(19) United States
(12) Patent Application Publication
(10) Pub. No.: US 2024/0244498 A1
(43) Pub. Date: Jul. 18, 2024

(54) AUTONOMOUS RADIO LINK FAILURE DURING RANDOM ACCESS PROCEDURE

(71) Applicant: QUALCOMM Incorporated, San Diego, CA (US)

(72) Inventors: Luis MUNOZ LOZA, San Diego, CA (US); Kiran Kumar Raavi, San Diego, CA (US); Kevin MURRAY, Escondido, CA (US)

(21) Appl. No.: 18/155,543

(22) Filed: Jan. 17, 2023

(51) Int. Cl. H04W 36/30; H04B 17/318; H04W 24/08; H04W 24/10; H04W 74/08

(52) U.S. Cl. CPC H04W 36/305; H04B 17/318; H04W 24/08; H04W 24/10; H04W 74/0833

(57) ABSTRACT

Methods, systems, and devices for wireless communications are described. A user equipment (UE) may perform a random access procedure to establish a connection with a first cell. The UE may measure, based on performing the random access procedure, a first reference signal received power of a first reference signal received from a first cell and measure a second reference signal received power for a second reference signal received from a second cell. The UE may calculate a transmission power for a random access preamble. The UE may trigger a radio link failure mode for the first cell based at least in part on the first reference signal received power being less than a first reference signal received power threshold, the second reference signal received power being greater than the first reference signal received power threshold, and the transmission power being greater than a transmission power threshold.

### FIELD OF TECHNOLOGY

The following relates to wireless communications, including autonomous radio link failure during random access procedure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may be configured to perform a random access procedure in a cell. In some examples, the UE performs the random access procedure in response to receiving a handover command from a network entity or in response to data arrival at the UE or at the network entity. The UE may transmit random access preambles until a successful transmission, until a random access trimer expires, until a threshold quantity of preamble transmissions is exceeded.

### SUMMARY

The described techniques relate to improved methods, systems, devices, and apparatuses that support autonomous radio link failure during random access procedure. For example, the described techniques provide for a user equipment (UE) performing a random access procedure to establish a connection with the first cell. The random access procedure may be performed in response to measurements of the first cell while communication with another cell. The UE may measure a first reference signal received power (RSRP) of a first reference signal received from the first cell and measure a second RSRP of a second reference signal received form a second cell. The UE may also calculate a transmission power for a random access preamble for the random access procedure. The UE may evaluate the first RSRP and the second RSRP relative to a RSRP threshold and the transmission power relative to a transmission power threshold, and trigger a radio link failure mode based on the evaluations. The radio link failure mode may cause the UE to exit the random access procedure in establish a connection with another cell.

### BRIEF DESCRIPTION OF THE DRAWINGS

FIG. 1 illustrates an example of a wireless communications system that supports autonomous radio link failure during random access procedure in accordance with one or more aspects of the present disclosure.

FIG. 2 illustrates an example of a wireless communications system that supports autonomous radio link failure during random access procedure in accordance with one or more aspects of the present disclosure.

FIG. 3 illustrates an example of a flowchart that supports autonomous radio link failure during random access procedure in accordance with one or more aspects of the present disclosure.

FIG. 4 illustrates an example of a process flow that supports autonomous radio link failure during random access procedure in accordance with one or more aspects of the present disclosure.

FIGS. 5 and 6 illustrate block diagrams of devices that support autonomous radio link failure during random access procedure in accordance with one or more aspects of the present disclosure.

FIG. 7 illustrates a block diagram of a communications manager that supports autonomous radio link failure during random access procedure in accordance with one or more aspects of the present disclosure.

FIG. 8 illustrates a diagram of a system including a device that supports autonomous radio link failure during random access procedure in accordance with one or more aspects of the present disclosure.

FIGS. 9 through 13 illustrate flowcharts showing methods that support autonomous radio link failure during random access procedure in accordance with one or more aspects of the present disclosure.

### DETAILED DESCRIPTION

A user equipment (UE) may communicate with a first serving cell over an established communication link. While communicating with the first cell, a cell overshoot may occur, whereby a signal from a second cell may be stronger than the first cell for a short period of time. This scenario may occur due to terrain, buildings, poor antenna location, or due to other factors. If the UE detects this overshooting signal, the UE may trigger measurement reports for the second cell, which may result in the base station activating a handover procedure such that the UE synchronizes with the second cell and initiates a random access procedure in the second cell. However, after handover, the signal in the second cell may rapidly deteriorate, which may result in the UE performing the random access procedure until a random access (RACH) timer expires or until RACH preamble transmissions reach a maximum value. As such, the UE may continue to try to connect with the second cell even though other cells (e.g., the first cell) may provide better service probability. This may result in high data interruption time, battery consummation, and unnecessary communication interference. Other scenarios may cause a UE to perform a random access procedure in a cell when another (neighboring) cell may provide better service probability.

Techniques described herein support a UE entering a radio link failure mode during a random access procedure if the UE detects one or more conditions. For example, the UE may consider whether the following three conditions are satisfied: (1) whether the target cell (e.g., cell where the UE is performing the random access procedure) reference signal received power (RSRP) is less than an RSRP threshold; (2) whether a neighboring cell RSRP is greater than the RSRP threshold; and (3) whether the latest calculated transmission power for a RACH preamble is greater than a transmission power threshold. The RSRP threshold may be dependent on whether a serving cell measurement reporting event is configured at the UE, such as eventA2. If the serving cell measurement reporting event is configured, then the threshold corresponds to the serving cell measurement reporting event (e.g., thresh A2). Otherwise, the UE may use the minimum required reception level in the cell as the threshold RSRP (e.g., qRxLevMin). In some examples, the UE may first evaluate whether a quantity of RACH preamble transmissions exceeds a threshold before evaluating the above conditions. This technique may be used in conjunction with various types of handover procedures including basic handover procedures and advanced handover procedures, including dual active protocol stack (DAPS) handover, conditional handover (CHO), and T312-based fast failure recovery handover. As such, the techniques described herein may limit or prevent a UE attempting to establish a connection with a cell via a random access procedure, when the cell is no longer providing adequate reception power and/or when another cell may be more suitable. That is, using the techniques described herein, the UE may efficiently exit the random access procedure in order to limit or prevent communications that may not result in a connection establishment. These and other techniques are described in further detail with respect to the figures.

Aspects of the disclosure are initially described in the context of wireless communications systems. Aspects of the disclosure are further described with respect to a wireless communications system, a flow chart, and a process flow. Aspects of the disclosure are further illustrated by and described with reference to apparatus diagrams, system diagrams, and flowcharts that relate to autonomous radio link failure during random access procedure.

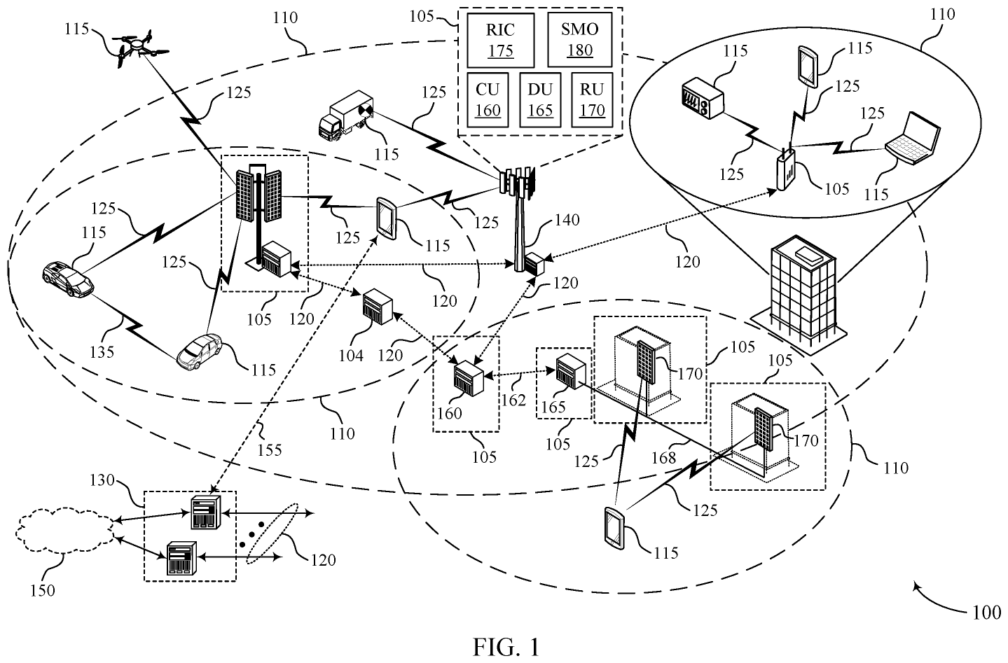

FIG. 1 illustrates an example of a wireless communications system 100 that supports autonomous radio link failure during random access procedure in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support autonomous radio link failure during random access procedure as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, a UE 115 of the wireless communications system 100 may communicate with various network entities 105 and various cells supported by the network entities 105. In some examples, a UE 115 may communicate with a source cell supported by one of the network entities 105 and may receive another signal transmitted in a cell supported by the same network entity 105 or a different network entity 105. The UE 115 may measure the received signal, which may trigger transmission of a measurement report in the source cell. In response to receiving the measurement report, the network entity 105 may instruct the UE 115 to perform a handover procedure to cause the UE 115 to establish a connection with the target cell that transmitted the signal via a random access procedure. The UE 115 may perform the random access procedure, but the signal quality of the target cell may quickly deteriorate, which may cause the UE 115 to perform the random access procedure until expiration of a random access timer or the quantity of random access preamble transmissions reach a maximum value. However, before expiration of the timer or before the preamble reach a maximum value, another cell (e.g., the source cell or another neighboring cell) may be suitable to support communications. However, as the UE 115 is performing the random access procedure, this scenario may result in high data interruption time, battery consumption, and unnecessary communication interference.

Techniques described herein support the UE 115 aborting a random access procedure when a set of conditions is satisfied. For example, if the UE 115 determines that a quantity of preamble transmission (e.g., RACH preamble transmissions) reaches a threshold (e.g., half of the maximum amount of RACH preamble transmission), then the UE may evaluate the set of conditions to determine whether to abort the random access procedure. The set of conditions may include whether the RSRP of the target cell is less than a threshold, whether the RSRP of another cell (e.g., the source cell or neighbor cell) is greater than the threshold, and whether the latest calculated transmission power for a RACH preamble is greater than a transmission power threshold. The RSRP threshold may be a threshold corresponding to a serving cell reporting event (e.g., an thresh A2 corresponding to eventA2) if the event is configured at the UE 115. Otherwise, the RSRP threshold may be a minimum required reception level in a cell (e.g., qRxLevMin), which may be configured for the cell. If the set of conditions is satisfied, the UE 115 may trigger a radio link failure mode, exit the random access procedure, and perform cell reselection in the other cell (e.g., the neighboring or source cell). As such, the UE 115 may abort the random access procedure, which may result in reduced or limited data interruption, reduced power consumption, and improved communication reliability, among other benefits.

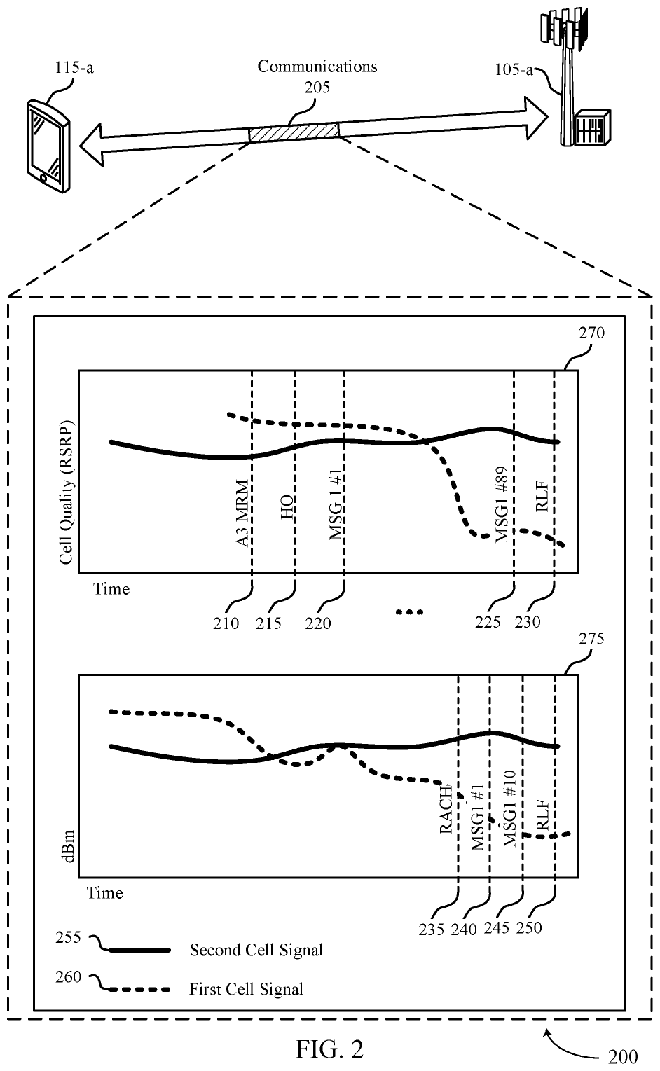

FIG. 2 illustrates an example of a wireless communications system 200 that supports autonomous radio link failure during random access procedure in accordance with one or more aspects of the present disclosure. The wireless communications system 200 includes a network entity 105-a and a UE 115-a, which may be examples of the network entities 105 and the UEs 115, as described with respect to FIG. 1. The wireless communications system 200 illustrates examples of communications 205 between the UE 115-a and one or more cells supported by the network entity 105-a or another network entity.

In some wireless communications systems, a UE may be communicating with a cell, measure a reference signal communication by another cell, and switch to communications in the other cell based on the cell measurements. However, these techniques may result in data interruption time, battery consumption, and unnecessary interface in the wireless communications system. For example, as illustrated in chart 270, the UE 115-a may be initially communicate with a source cell (e.g., second cell signal 255). While the UE 115-a is communicating in the source cell, the UE 115-a may detect and measure a signal transmitted by another cell (e.g., the first cell signal 260). The UE 115-a may measure the first cell signal 260 based on a measurement configuration, at 210, such as an eventA3 measurement configuration. According to the eventA3 measurement configuration, the neighbor cell (e.g., the first cell) may become offset better than the source cell. In such cases, the measurement event at 210 may cause the UE 115-a to perform a handover procedure at 215 in the neighbor cell/target cell. In some examples, the UE 115-a reports the measurement to the network entity 105-a, and the network entity 105-a may send a handover command to the UE 115-a based on the measurement report.

In such cases, the UE 115-a may perform a random access procedure with the first cell and transmit a Msg1 of the random access procedure at 220. The UE 115-a may continue the random access procedure with the first cell, but the signal quality in the first cell may deteriorate, as illustrated in chart 270. The rapid deterioration of the first cell signal 260 may result in the random access procedure being unsuccessful in the target cell, as illustrated by an 89th transmission of the Msg1 of the random access procedure at 225. As such, the UE 115-a may trigger a radio link failure mode at 230 and may perform sell reselection in another cell, such as the source cell or another neighboring cell. The UE may trigger the radio link failure mode based on a random access timer (T304) expiring (e.g., two seconds). The scenario of chart 270 may be a result of a cell overshooter, which may be caused by terrain, buildings, poor antenna location, etc. In such cases, the overshooting signal may be stronger than the serving cell, which results in the UE triggering eventA3 measurements and the handover procedure.

In some cases, a random access procedure may be triggered in response to arrival of uplink or downlink data for the UE 115-a. In such cases, the random access procedure is performed until a quantity of random access preamble transmissions reaches a threshold (e.g., preambleTransMax value) even when the serving cell has high path loss values and other cells may provide better service probability. As illustrated in chart 275, at 235, the UE 115-a may perform a random access procedure with the first cell based on the first cell signal 260 in response to data arrival. The UE 115-a may perform the random access procedure with the first cell based on the first cell signal having a higher signal quality initially. The UE 115-a may transmit Msg11 of the random access procedure at 240, and transmit a tenth iteration of the Msg1 at 245. The UE 115-a may trigger the radio link failure mode as a result of the random access timer expiring or due to the preamble transmissions reaching the threshold.

The UE 115-a may avoid the scenarios illustrated in the chart 270 and in the chart 275 (among other scenarios) by being configured to abort the random access procedure based on various conditions and enter a radio link failure (RLF) mode. For example, the UE 115-a may abort the random access procedure according to the following considerations:

```
● If eventA2 is configured:
    ◯ If preamble_counter > preambleTransMax / 2:
        ▪ If serving_RSRP + hys < thresh_A2; and
        ▪ neighbor_RSRP + hys > thresh_A2; and
        ▪ latest_preamble_power > maximum output power:
            ● trigger RLF
● else:
    ◯ if serving_RSRP + hys < qRxLevMin, and
    ◯ neighbor_RSRP + hys > qRxLevMin; and
    ◯ latest_preamble_power > maximum output power:
        ▪ trigger RLF
```

In this example, preamble_counter is the maximum quantity of random access preamble transmissions, preambleTransMax is the maximum quantity of random access preamble transmission performed before declaring a radio link failure, hys is the hysteresis, thresh A2 is the threshold parameter for eventA2, neighbor_RSRP is the measurement result of a neighbor cell, not accounting for any offsets, latest_preamble_power is the latest calculated preamble power, and qRxLevMin is the minimum required reception level in the cell. As such, if eventA2 is configured at the UE 115-a, the UE evaluates a measurement of the serving cell (e.g., the first cell signal 260) or the cell in which the UE 115-a is performing the random access procedure and evaluates a measurement of a neighboring cell relative to the eventA2 threshold. The UE 115-a also considers whether a calculated transmission power for the next preamble transmission is greater than a maximum power, which may be a UE power limitation (e.g., based on the class of the UE 115-a). If the UE 115-a is not configured with eventA2, then the UE 115-a may utilize a minimum required reception level for the cell for evaluating the cell in which the UE 115-a is performing the random access procedure and the neighboring cell. In some examples, the neighboring cell is the source cell (e.g., the cell that the UE 115-a switched from due to the handover command).

Using these techniques, the UE 115-a may abort a random access procedure before expiration of the random access timer or before the maximum quantity of random access preamble transmissions is satisfied when the neighboring cell may support more efficient communications due to having a higher signal quality. That is, the UE 115-a may more efficiently switch to a cell that has a higher signal quality, which may reduce the impact of a cell overshooter, data arrival causing a random access procedure, or other factors that may cause a random access procedure.

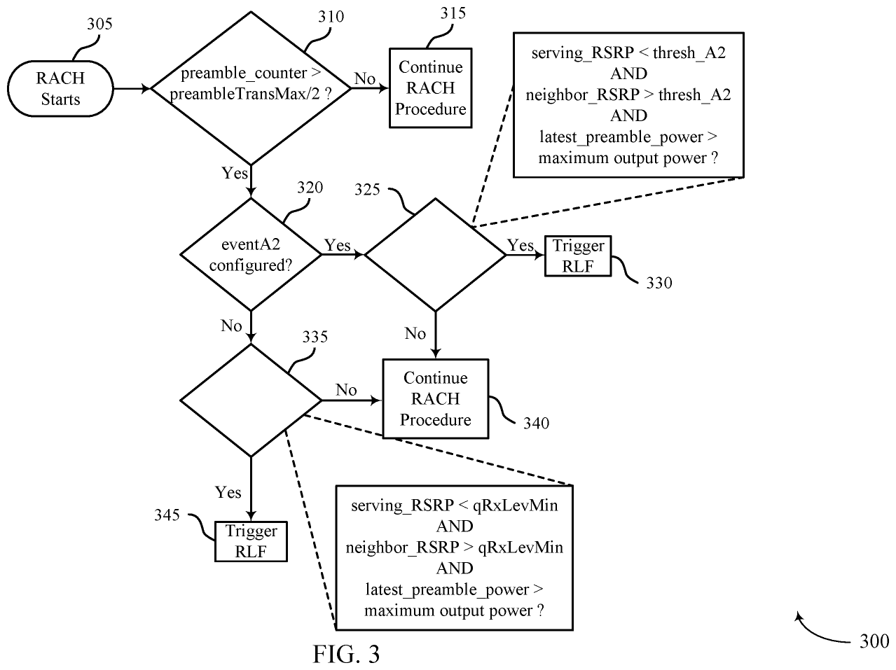

FIG. 3 illustrates an example of a flowchart 300 that supports autonomous radio link failure during random access procedure in accordance with one or more aspects of the present disclosure. Procedures of the flowchart 300 may be implemented by a UE 115, as described with respect to FIG. 1 and FIG. 2.

At 305, the UE 115 may imitate a random access procedure in a first cell. The UE 115 may initiate the random access procedure due to a handover command received from a network entity 105, due to data arrival at the network or at the UE 115, and/or due to another condition. The UE 115 may transmit a set of random access preamble transmissions for the random access procedure.

In some examples, the random access procedure may be performed as part of advanced handover procedures, such as a dual active protocol stack (DAPS) handover, a conditional handover (CHO), or a T313-based fast failover recovery. For example, in the DAPS handover, the UE 115 may receive a radio resource control (RRC) message that includes a configuration, per data radio bearer (DRB), of the DAPS handover. In response, the UE 115 may connect to the target network entity 105 and perform a random access procedure in the target cell, and the techniques described herein may allow the UE 115 to abort the random access procedure in the target cell. In such cases, the UE may abort the random access procedure before the timer is finished to save UE power and to reduce interference to the system. Additionally, the UE may continue the session in the source cell. In the CHO procedure, the UE 115 may receive a RRC reconfiguration message that includes CHO execution conditions and CHO candidate cells. The UE 115 respond to the RRC message with a RRC configuration complete message, evaluate CHO execution conditions, connect to a target network entity and perform the random access procedure in the target cell. The techniques described may allow the UE 115 to abort the random access procedure in the target cell. For T312-based fast failover recovery, the UE 115 may receive the handover command before the T312 and the RACH procedure is started. The techniques described herein may support the UE 115 exiting the procedure if the conditions are satisfied.

At 310, the UE 115 may determine whether a quantity of random access preamble transmissions satisfy a preamble transmission threshold. In some examples, the preamble transmission threshold is half the preambleTransMax parameter, which may be configured at the UE 115. It should be understood that another portion or another threshold may be used in accordance with aspects of the present disclosure. If the quantity of random access preamble transmissions does not exceed the threshold, then, at 315, the UE 115 may continue the random access procedure, which may include additional random access preamble transmissions. If the quantity of random access preamble transmissions is greater than the threshold, then, at 320, the UE 115 may determine whether a serving cell reporting event (e.g., eventA2) is configured at the UE 115. If the serving cell reporting event is configured, then the UE 115 may evaluate a set of conditions at 325. For example, at 325, the UE 115 may determine if a serving cell RSRP is less than the threshold corresponding to the serving cell reporting event (e.g., the thresh A2) and if the neighbor cell RSRP is greater than the same threshold. The UE 115 may also determine if latest calculated preamble transmission power is greater than a maximum output power of the UE 115. If these three conditions are true, then the UE may trigger a radio link failure mode for the serving cell at 330. If one or more of these conditions are not satisfied, then the UE 115 may continue the RACH procedure at 340.

If the serving cell reporting event (e.g., eventA2) is not configured, then the UE 115 may evaluate another set of conditions, at 335. For example, at 335, the UE 115 may determine if a serving cell RSRP is less than a minimum required receive power in the serving cell (e.g., qRXLevMin) and if the neighbor cell RSRP is greater than the same threshold. The UE 115 may also determine if a latest calculated preamble transmission power is greater than a maximum output power of the UE 115. If these three conditions are true, then the UE may trigger a radio link failure mode for the serving cell at 345. If one or more of these conditions are not satisfied, then the UE 115 may continue the RACH procedure at 340. Thus, the threshold for evaluating the RSRP may be dependent on whether the event (e.g., eventA2) is configured at the UE 115.

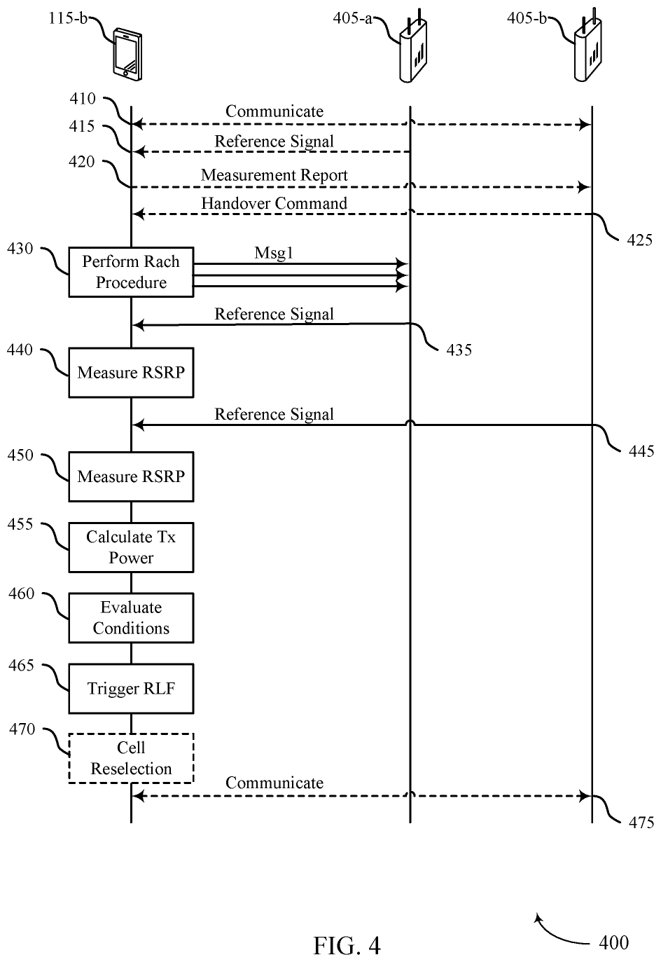

FIG. 4 illustrates an example of a process flow 400 that supports autonomous radio link failure during random access procedure in accordance with one or more aspects of the present disclosure. The process flow 400 includes a UE 115-b, a cell 405-a, and a cell 405-b. The UE 115-b may be an example of the UEs 115 as described with respect to FIGS. 1 through 3, and the cells 405 may be examples of the cells as described with respect to FIGS. 1 through 3. The cells 405 may be supported by one or more network entities 105 as described with respect to FIGS. 1 through 3. In the following description of the process flow 400, the operations between the UE 115-b and the cells 405 may be transmitted in a different order than the example order shown, or the operations performed may be performed in different orders or at different times. Some operations may also be omitted from the process flow 400, and other operations may be added to the process flow 400.

At 410, the UE 115-b may communicate with the cell 405-b. At 415, the UE 115-b may receive a reference signal from the cell 405-a and measure the reference signal. The measurement may trigger a measurement report (e.g., an eventA3 measurement report). As such, at 420, the UE 115-b may transmit a measurement report to a network entity associated with the cell 405-b. At 425, the network entity corresponding to cell 405-b may transmit a handover command to the UE 115-b. The operations at 430 through 475 are illustrated as being performed in response to the handover command received at 425. However, it should be understood that the operations at 430 through 475 may be performed based on other events, such as data arrival at the network and/or the UE 115-b.

At 430, the UE 115-b performs a random access procedure to establish a connection with the cell 405-a (e.g., a first cell). Performing the random access procedure may include transmitting random access preambles via Msg1 transmissions.

At 435, the UE 115-b may receive a reference signal from the cell 405-a, and at 440, the UE 115-b may measure, in response to performing the random access procedure, a first reference signal receive power of the reference signal received from the cell 405-a. At 445, the UE 115-a may receive a reference signal from the cell 405-b, and, at 450, the UE 115-b may measure, in response to performing the random access procedure, a second reference signal received power for the reference signal received from the cell 405-b. It should be understood that the cell 405-b that transmits the second reference signal may be different from the cell in which the UE 115-b is communicating via operations at 410 and 425. That is, the UE 115-b may detect a different cell that then cell that transmits the handover command. As such, the UE 115-b may detect and receive the reference signal transmitted the neighboring cell 405-b while performing the random access procedure at 430. Thus, the source cell and the neighboring cell may be different cells.

At 455, the UE 115-a may calculate, based at least in part on performing the random access procedure, a transmission power for a random access preamble. That is, for each unsuccessful random access preamble transmission, the UE 115-a may calculate a new (increased) transmission power for a subsequent random access preamble transmission. Thus, the UE may calculate a next preamble transmission power.

At 460, the UE 115-a may evaluate a set of conditions to determine whether to abort the random access procedure and trigger a radio link failure mode in the cell 405-a. In some examples, the UE 115-a may determine a RSRP power threshold. The RSRP threshold may be determined based on whether the UE 115-a is configured with a serving cell measurement reporting event (e.g., eventA2). If the UE 115-a is configured with the serving cell measurement reporting event, then the UE 115-a may determine to use the threshold corresponding to the serving cell measurement reporting event. If the UE 115-a is not configured with the serving cell reporting event, then the UE 115-a may use a threshold corresponding to a minimum required receive power threshold (e.g., qRxLevMin).

Thus, at 460, the UE 115-a may determine whether a quantity of random access preamble transmissions exceeds a threshold quantity of random access preamble transmissions, whether a first reference signal received power (of the reference signal measured at 440) exceeds the determined reference signal received power threshold, whether a second reference signal received power (of the reference signal measured at 450) exceeds the determined reference signal received power threshold, and whether the transmission power for the random access preamble is greater than the transmission power threshold.

At 465, the UE 115-a may trigger a radio link failure mode for the first cell based at least in part on the first reference signal received power being less than a first reference signal received power threshold, the second reference signal received power being greater than the first reference signal received power threshold, and the transmission power being greater than a transmission power threshold. The radio link failure mode may also be triggered based on the quantity of random access preamble transmissions exceeding a threshold quantity of random access preamble transmissions.

At 470, the UE 115-a may perform, in response to triggering the radio link failure mode in the first cell, a cell reselection procedure. At 475, the UE 115-a may establish a connection with the second cell based at least in part on performing the cell reselection procedure.

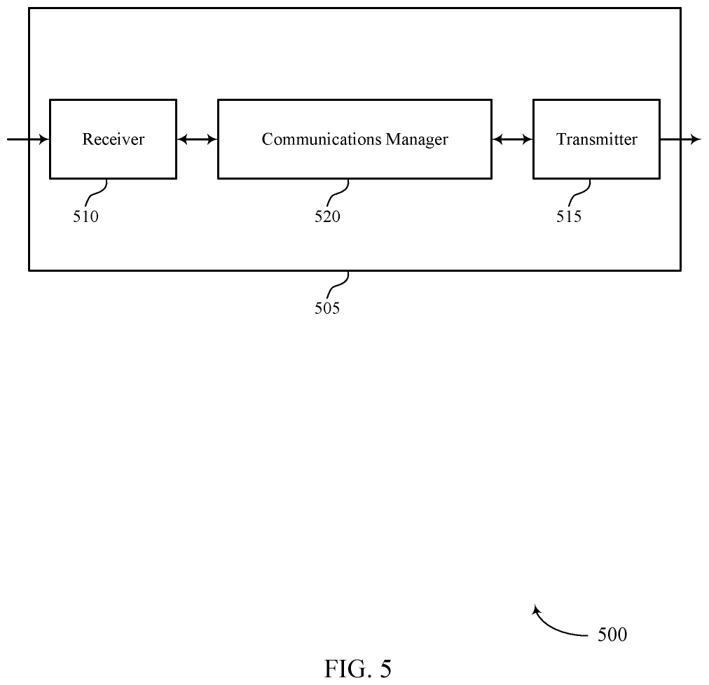

FIG. 5 illustrates a block diagram 500 of a device 505 that supports autonomous radio link failure during random access procedure in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to autonomous radio link failure during random access procedure). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to autonomous radio link failure during random access procedure). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of autonomous radio link failure during random access procedure as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

Additionally, or alternatively, the communications manager 520 may support wireless communication at a UE in accordance with examples as disclosed herein. For example, the communications manager 520 may be configured as or otherwise support a means for performing a random access procedure to establish a connection with a first cell. The communications manager 520 may be configured as or otherwise support a means for measuring, in response to performing the random access procedure, a first reference signal received power of a first reference signal received from a first cell. The communications manager 520 may be configured as or otherwise support a means for measuring, in response to performing the random access procedure, a second reference signal received power for a second reference signal received from a second cell. The communications manager 520 may be configured as or otherwise support a means for calculating, based on performing the random access procedure, a transmission power for a random access preamble. The communications manager 520 may be configured as or otherwise support a means for triggering a radio link failure mode for the first cell based on the first reference signal received power being less than a first reference signal received power threshold, the second reference signal received power being greater than the first reference signal received power threshold, and the transmission power being greater than a transmission power threshold.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and improved communication reliability based on efficient random access procedure aborting based on serving cell and neighboring cell measurements, among other conditions.

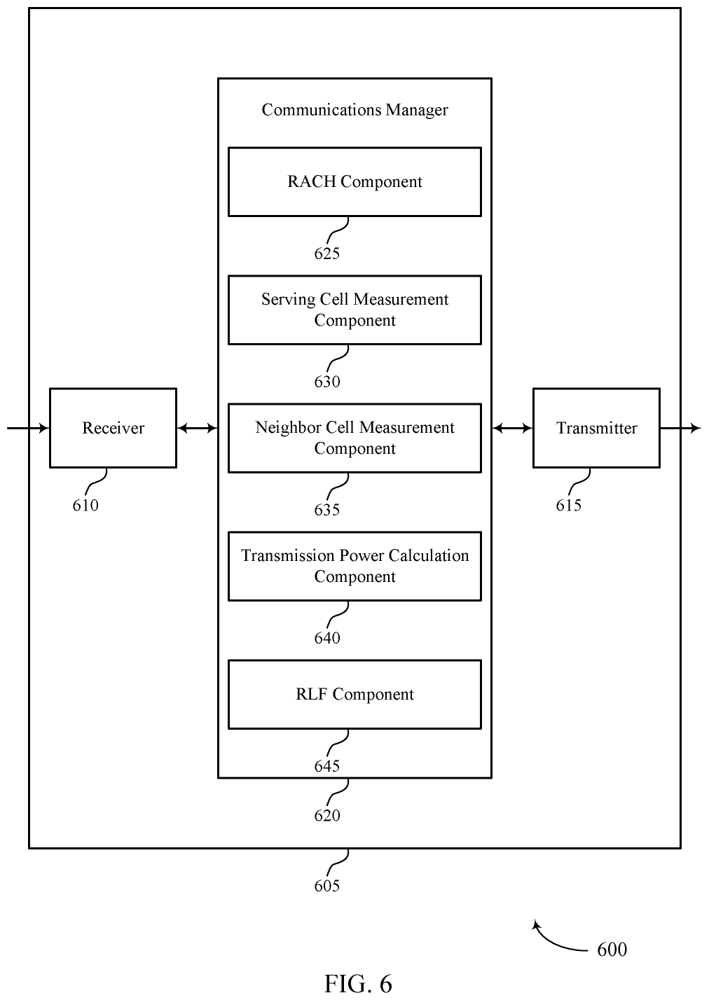

FIG. 6 illustrates a block diagram 600 of a device 605 that supports autonomous radio link failure during random access procedure in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to autonomous radio link failure during random access procedure). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to autonomous radio link failure during random access procedure). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of autonomous radio link failure during random access procedure as described herein. For example, the communications manager 620 may include a RACH component 625, a serving cell measurement component 630, a neighbor cell measurement component 635, a transmission power calculation component 640, an RLF component 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The RACH component 625 may be configured as or otherwise support a means for performing a random access procedure to establish a connection with a first cell. The serving cell measurement component 630 may be configured as or otherwise support a means for measuring, in response to performing the random access procedure, a first reference signal received power of a first reference signal received from a first cell. The neighbor cell measurement component 635 may be configured as or otherwise support a means for measuring, in response to performing the random access procedure, a second reference signal received power for a second reference signal received from a second cell. The transmission power calculation component 640 may be configured as or otherwise support a means for calculating, based on performing the random access procedure, a transmission power for a random access preamble. The RLF component 645 may be configured as or otherwise support a means for triggering a radio link failure mode for the first cell based on the first reference signal received power being less than a first reference signal received power threshold, the second reference signal received power being greater than the first reference signal received power threshold, and the transmission power being greater than a transmission power threshold.

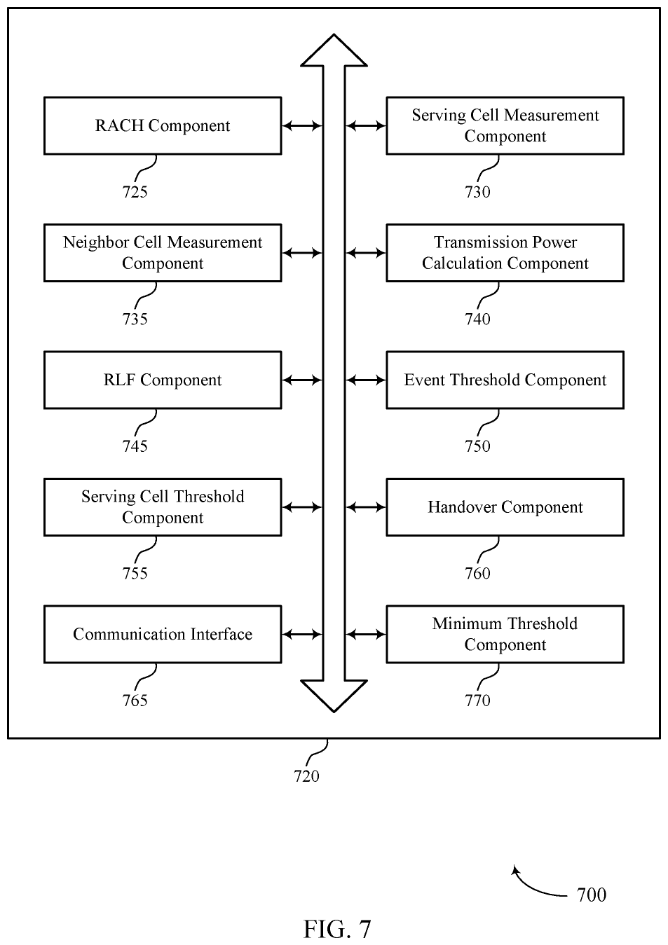

FIG. 7 illustrates a block diagram 700 of a communications manager 720 that supports autonomous radio link failure during random access procedure in accordance with one or more aspects of the present disclosure. The communications manager 720 may be an example of aspects of a communications manager 520, a communications manager 620, or both, as described herein. The communications manager 720, or various components thereof, may be an example of means for performing various aspects of autonomous radio link failure during random access procedure as described herein. For example, the communications manager 720 may include a RACH component 725, a serving cell measurement component 730, a neighbor cell measurement component 735, a transmission power calculation component 740, an RLF component 745, an event threshold component 750, a serving cell threshold component 755, a handover component 760, a communication interface 765, a minimum threshold component 770, or any combination thereof. Each of these components may communicate, directly or indirectly, with one another (e.g., via one or more buses).

Additionally, or alternatively, the communications manager 720 may support wireless communication at a UE in accordance with examples as disclosed herein. The RACH component 725 may be configured as or otherwise support a means for performing a random access procedure to establish a connection with a first cell. The serving cell measurement component 730 may be configured as or otherwise support a means for measuring, in response to performing the random access procedure, a first reference signal received power of a first reference signal received from a first cell. The neighbor cell measurement component 735 may be configured as or otherwise support a means for measuring, in response to performing the random access procedure, a second reference signal received power for a second reference signal received from a second cell. The transmission power calculation component 740 may be configured as or otherwise support a means for calculating, based on performing the random access procedure, a transmission power for a random access preamble. The RLF component 745 may be configured as or otherwise support a means for triggering a radio link failure mode for the first cell based on the first reference signal received power being less than a first reference signal received power threshold, the second reference signal received power being greater than the first reference signal received power threshold, and the transmission power being greater than a transmission power threshold.

In some examples, the event threshold component 750 may be configured as or otherwise support a means for using a reference signal received power threshold corresponding to a serving cell measurement reporting event as the first reference signal received power threshold based on the serving cell measurement reporting event being configured at the UE.

In some examples, to support using the reference signal received power threshold corresponding to serving cell measurement event, the minimum threshold component 770 may be configured as or otherwise support a means for using, as the first reference signal received power threshold, a minimum reference signal received power threshold of a set of multiple reference signal received power thresholds corresponding to the serving cell measurement reporting event that is configured at the UE.

In some examples, to support triggering the radio link failure mode, the RLF component 745 may be configured as or otherwise support a means for triggering the radio link failure mode based on a quantity of random access preamble transmissions exceeding a threshold quantity of random access preamble transmissions.

In some examples, the threshold quantity of random access preamble transmissions is half of a maximum quantity of preamble transmissions configured at the UE.

In some examples, the event threshold component 750 may be configured as or otherwise support a means for determining that a serving cell measurement reporting event is not configured at the UE. In some examples, the serving cell threshold component 755 may be configured as or otherwise support a means for using a threshold corresponding to a minimum required receive power threshold in the first cell as the first reference signal received power threshold based on determining that the serving cell measurement reporting event is not configured at the UE.

In some examples, the transmission power threshold is a maximum output power of the UE.

In some examples, the handover component 760 may be configured as or otherwise support a means for performing a handover procedure for the first cell, where the random access procedure is performed in response to performing the handover procedure.

In some examples, the handover procedure is a dual active protocol stack (DAPS) handover, a conditional handover (CHO), or a T312-based fast failure recovery handover.

In some examples, the communication interface 765 may be configured as or otherwise support a means for communicating via the second cell prior to performing the random access procedure. In some examples, the handover component 760 may be configured as or otherwise support a means for receiving, from the second cell based on a measurement of the second cell, a handover command, where the random access procedure is performed in the first cell in response to receiving the handover command.

In some examples, the second cell is a neighbor cell and the UE communicates with a source cell prior to performing the random procedure in the first cell.

In some examples, to support triggering the radio link failure mode, the serving cell measurement component 730 may be configured as or otherwise support a means for evaluating whether the first reference signal received power plus a hysteresis value is less than the first reference signal received power threshold, where the radio link failure mode for the first cell is triggered based on the first reference signal received power plus the hysteresis value being less than the first reference signal received power threshold.

In some examples, to support triggering the radio link failure mode, the neighbor cell measurement component 735 may be configured as or otherwise support a means for evaluating whether the second reference signal received power plus a hysteresis value is greater than the first reference signal received power threshold, where the radio link failure mode for the first cell is triggered based on the second reference signal received power plus the hysteresis value being greater than the first reference signal received power threshold.

In some examples, the RLF component 745 may be configured as or otherwise support a means for performing, in response to triggering the radio link failure mode in the first cell, a cell reselection procedure. In some examples, the communication interface 765 may be configured as or otherwise support a means for establishing a connection with the second cell based on performing the cell reselection procedure.

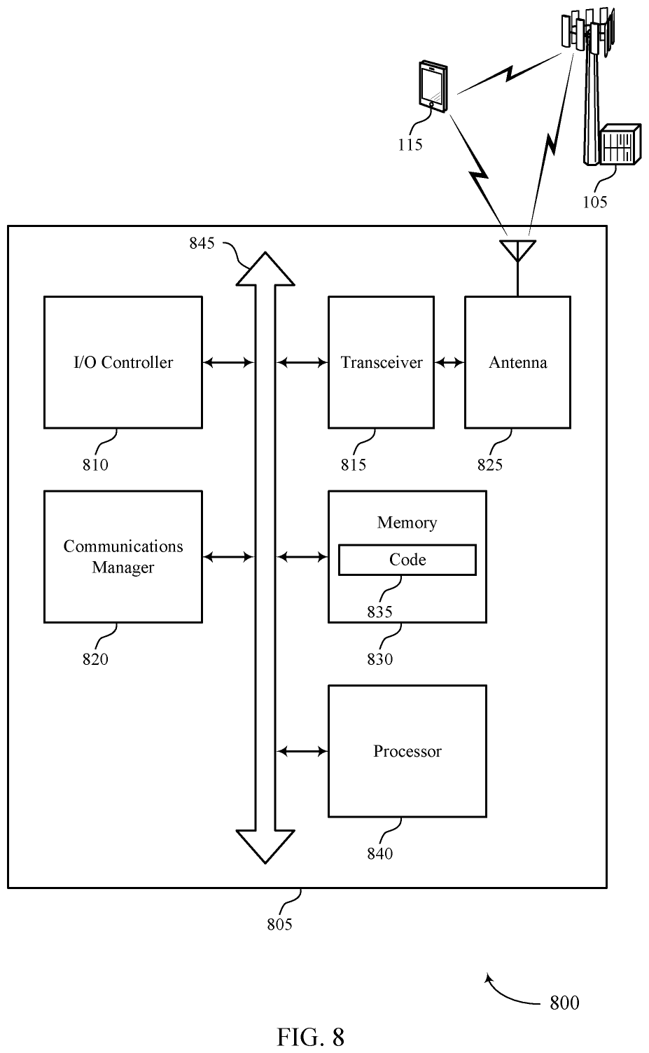

FIG. 8 illustrates a diagram of a system 800 including a device 805 that supports autonomous radio link failure during random access procedure in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting autonomous radio link failure during random access procedure). For example, the device 805 or a component of the device 805 may include a processor 840 and memory 830 coupled with or to the processor 840, the processor 840 and memory 830 configured to perform various functions described herein.

Additionally, or alternatively, the communications manager 820 may support wireless communication at a UE in accordance with examples as disclosed herein. For example, the communications manager 820 may be configured as or otherwise support a means for performing a random access procedure to establish a connection with a first cell. The communications manager 820 may be configured as or otherwise support a means for measuring, in response to performing the random access procedure, a first reference signal received power of a first reference signal received from a first cell. The communications manager 820 may be configured as or otherwise support a means for measuring, in response to performing the random access procedure, a second reference signal received power for a second reference signal received from a second cell. The communications manager 820 may be configured as or otherwise support a means for calculating, based on performing the random access procedure, a transmission power for a random access preamble. The communications manager 820 may be configured as or otherwise support a means for triggering a radio link failure mode for the first cell based on the first reference signal received power being less than a first reference signal received power threshold, the second reference signal received power being greater than the first reference signal received power threshold, and the transmission power being greater than a transmission power threshold.

By including or configuring the communications manager 820 in accordance with examples as described herein, the device 805 may support techniques for reduced processing, reduced power consumption, and improved communication reliability based on efficient random access procedure aborting based on serving cell and neighboring cell measurements, among other conditions.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of autonomous radio link failure during random access procedure as described herein, or the processor 840 and the memory 830 may be otherwise configured to perform or support such operations.

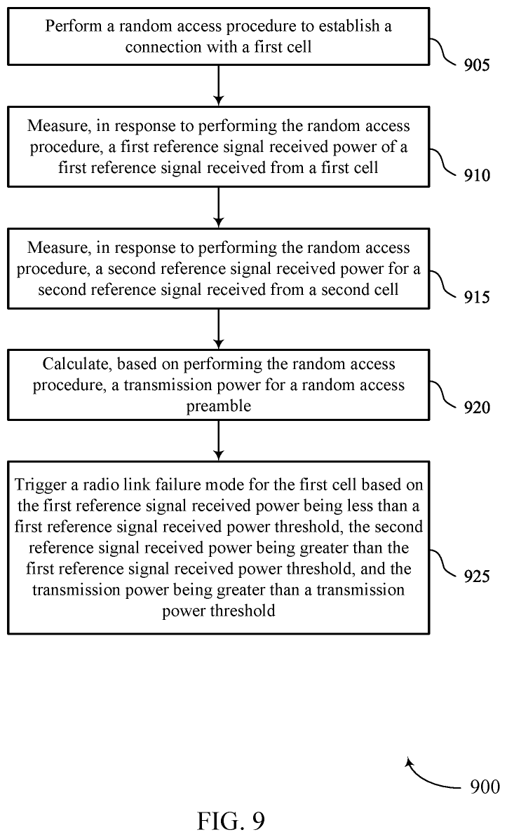

FIG. 9 illustrates a flowchart showing a method 900 that supports autonomous radio link failure during random access procedure in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include performing a random access procedure to establish a connection with a first cell. The operations of 905 may be performed in accordance with examples as disclosed herein. In some examples, aspects of the operations of 905 may be performed by a RACH component 725 as described with reference to FIG. 7.

At 910, the method may include measuring, in response to performing the random access procedure, a first reference signal received power of a first reference signal received from a first cell. The operations of 910 may be performed in accordance with examples as disclosed herein. In some examples, aspects of the operations of 910 may be performed by a serving cell measurement component 730 as described with reference to FIG. 7.

At 915, the method may include measuring, in response to performing the random access procedure, a second reference signal received power for a second reference signal received from a second cell. The operations of 915 may be performed in accordance with examples as disclosed herein. In some examples, aspects of the operations of 915 may be performed by a neighbor cell measurement component 735 as described with reference to FIG. 7.

At 920, the method may include calculating, based on performing the random access procedure, a transmission power for a random access preamble. The operations of 920 may be performed in accordance with examples as disclosed herein. In some examples, aspects of the operations of 920 may be performed by a transmission power calculation component 740 as described with reference to FIG. 7.

At 925, the method may include triggering a radio link failure mode for the first cell based on the first reference signal received power being less than a first reference signal received power threshold, the second reference signal received power being greater than the first reference signal received power threshold, and the transmission power being greater than a transmission power threshold. The operations of 925 may be performed in accordance with examples as disclosed herein. In some examples, aspects of the operations of 925 may be performed by an RLF component 745 as described with reference to FIG. 7.

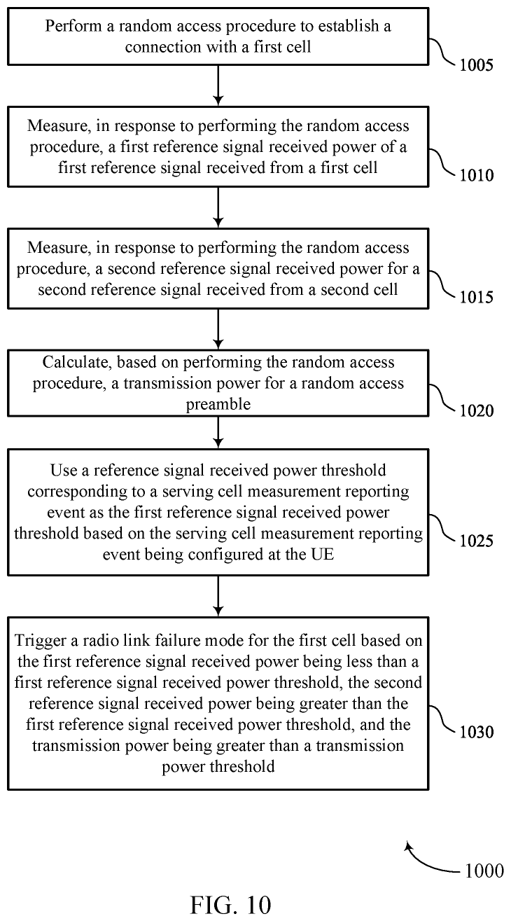

FIG. 10 illustrates a flowchart showing a method 1000 that supports autonomous radio link failure during random access procedure in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include performing a random access procedure to establish a connection with a first cell. The operations of 1005 may be performed in accordance with examples as disclosed herein. In some examples, aspects of the operations of 1005 may be performed by a RACH component 725 as described with reference to FIG. 7.

At 1010, the method may include measuring, in response to performing the random access procedure, a first reference signal received power of a first reference signal received from a first cell. The operations of 1010 may be performed in accordance with examples as disclosed herein. In some examples, aspects of the operations of 1010 may be performed by a serving cell measurement component 730 as described with reference to FIG. 7.

At 1015, the method may include measuring, in response to performing the random access procedure, a second reference signal received power for a second reference signal received from a second cell. The operations of 1015 may be performed in accordance with examples as disclosed herein. In some examples, aspects of the operations of 1015 may be performed by a neighbor cell measurement component 735 as described with reference to FIG. 7.

At 1020, the method may include calculating, based on performing the random access procedure, a transmission power for a random access preamble. The operations of 1020 may be performed in accordance with examples as disclosed herein. In some examples, aspects of the operations of 1020 may be performed by a transmission power calculation component 740 as described with reference to FIG. 7.

At 1025, the method may include using a reference signal received power threshold corresponding to a serving cell measurement reporting event as the first reference signal received power threshold based on the serving cell measurement reporting event being configured at the UE. The operations of 1025 may be performed in accordance with examples as disclosed herein. In some examples, aspects of the operations of 1025 may be performed by an event threshold component 750 as described with reference to FIG. 7.

At 1030, the method may include triggering a radio link failure mode for the first cell based on the first reference signal received power being less than a first reference signal received power threshold, the second reference signal received power being greater than the first reference signal received power threshold, and the transmission power being greater than a transmission power threshold. The operations of 1030 may be performed in accordance with examples as disclosed herein. In some examples, aspects of the operations of 1030 may be performed by an RLF component 745 as described with reference to FIG. 7.

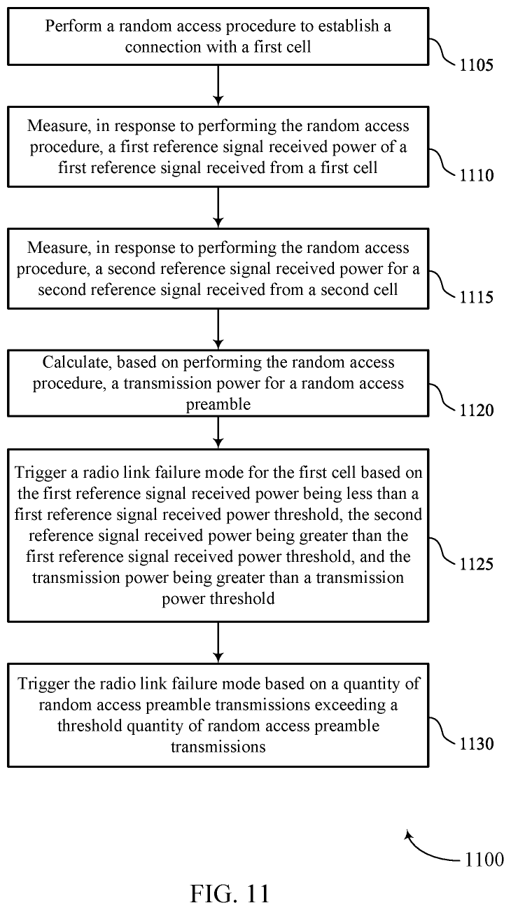

FIG. 11 illustrates a flowchart showing a method 1100 that supports autonomous radio link failure during random access procedure in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include performing a random access procedure to establish a connection with a first cell. The operations of 1105 may be performed in accordance with examples as disclosed herein. In some examples, aspects of the operations of 1105 may be performed by a RACH component 725 as described with reference to FIG. 7.

At 1110, the method may include measuring, in response to performing the random access procedure, a first reference signal received power of a first reference signal received from a first cell. The operations of 1110 may be performed in accordance with examples as disclosed herein. In some examples, aspects of the operations of 1110 may be performed by a serving cell measurement component 730 as described with reference to FIG. 7.

At 1115, the method may include measuring, in response to performing the random access procedure, a second reference signal received power for a second reference signal received from a second cell. The operations of 1115 may be performed in accordance with examples as disclosed herein. In some examples, aspects of the operations of 1115 may be performed by a neighbor cell measurement component 735 as described with reference to FIG. 7.

At 1120, the method may include calculating, based on performing the random access procedure, a transmission power for a random access preamble. The operations of 1120 may be performed in accordance with examples as disclosed herein. In some examples, aspects of the operations of 1120 may be performed by a transmission power calculation component 740 as described with reference to FIG. 7.

At 1125, the method may include triggering a radio link failure mode for the first cell based on the first reference signal received power being less than a first reference signal received power threshold, the second reference signal received power being greater than the first reference signal received power threshold, and the transmission power being greater than a transmission power threshold. The operations of 1125 may be performed in accordance with examples as disclosed herein. In some examples, aspects of the operations of 1125 may be performed by an RLF component 745 as described with reference to FIG. 7.

At 1130, the method may include triggering the radio link failure mode based on a quantity of random access preamble transmissions exceeding a threshold quantity of random access preamble transmissions. The operations of 1130 may be performed in accordance with examples as disclosed herein. In some examples, aspects of the operations of 1130 may be performed by an RLF component 745 as described with reference to FIG. 7.

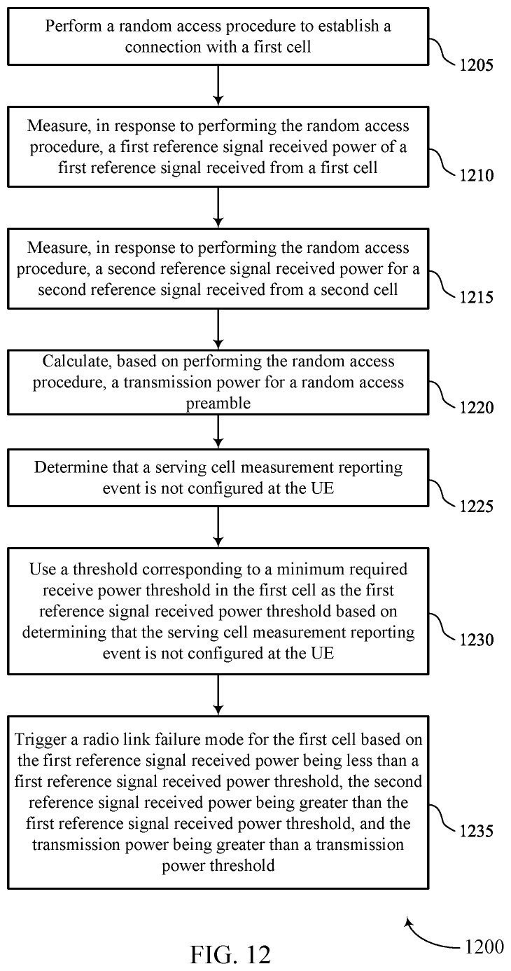

FIG. 12 illustrates a flowchart showing a method 1200 that supports autonomous radio link failure during random access procedure in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include performing a random access procedure to establish a connection with a first cell. The operations of 1205 may be performed in accordance with examples as disclosed herein. In some examples, aspects of the operations of 1205 may be performed by a RACH component 725 as described with reference to FIG. 7.

At 1210, the method may include measuring, in response to performing the random access procedure, a first reference signal received power of a first reference signal received from a first cell. The operations of 1210 may be performed in accordance with examples as disclosed herein. In some examples, aspects of the operations of 1210 may be performed by a serving cell measurement component 730 as described with reference to FIG. 7.

At 1215, the method may include measuring, in response to performing the random access procedure, a second reference signal received power for a second reference signal received from a second cell. The operations of 1215 may be performed in accordance with examples as disclosed herein. In some examples, aspects of the operations of 1215 may be performed by a neighbor cell measurement component 735 as described with reference to FIG. 7.

At 1220, the method may include calculating, based on performing the random access procedure, a transmission power for a random access preamble. The operations of 1220 may be performed in accordance with examples as disclosed herein. In some examples, aspects of the operations of 1220 may be performed by a transmission power calculation component 740 as described with reference to FIG. 7.

At 1225, the method may include determining that a serving cell measurement reporting event is not configured at the UE. The operations of 1225 may be performed in accordance with examples as disclosed herein. In some examples, aspects of the operations of 1225 may be performed by an event threshold component 750 as described with reference to FIG. 7.

At 1230, the method may include using a threshold corresponding to a minimum required receive power threshold in the first cell as the first reference signal received power threshold based on determining that the serving cell measurement reporting event is not configured at the UE. The operations of 1230 may be performed in accordance with examples as disclosed herein. In some examples, aspects of the operations of 1230 may be performed by a serving cell threshold component 755 as described with reference to FIG. 7.

At 1235, the method may include triggering a radio link failure mode for the first cell based on the first reference signal received power being less than a first reference signal received power threshold, the second reference signal received power being greater than the first reference signal received power threshold, and the transmission power being greater than a transmission power threshold. The operations of 1235 may be performed in accordance with examples as disclosed herein. In some examples, aspects of the operations of 1235 may be performed by an RLF component 745 as described with reference to FIG. 7.

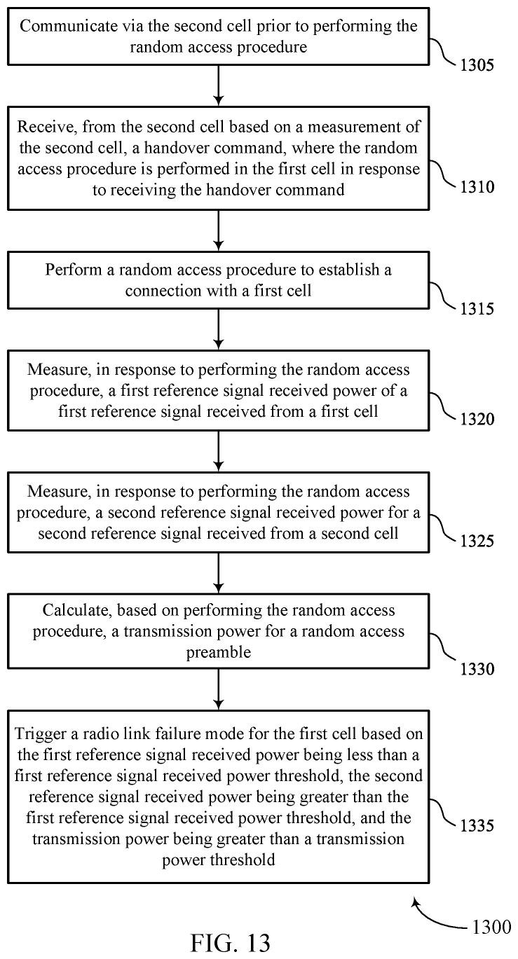

FIG. 13 illustrates a flowchart showing a method 1300 that supports autonomous radio link failure during random access procedure in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include communicating via the second cell prior to performing the random access procedure. The operations of 1305 may be performed in accordance with examples as disclosed herein. In some examples, aspects of the operations of 1305 may be performed by a communication interface 765 as described with reference to FIG. 7.

At 1310, the method may include receiving, from the second cell based on a measurement of the second cell, a handover command, where the random access procedure is performed in the first cell in response to receiving the handover command. The operations of 1310 may be performed in accordance with examples as disclosed herein. In some examples, aspects of the operations of 1310 may be performed by a handover component 760 as described with reference to FIG. 7.

At 1315, the method may include performing a random access procedure to establish a connection with a first cell. The operations of 1315 may be performed in accordance with examples as disclosed herein. In some examples, aspects of the operations of 1315 may be performed by a RACH component 725 as described with reference to FIG. 7.

At 1320, the method may include measuring, in response to performing the random access procedure, a first reference signal received power of a first reference signal received from a first cell. The operations of 1320 may be performed in accordance with examples as disclosed herein. In some examples, aspects of the operations of 1320 may be performed by a serving cell measurement component 730 as described with reference to FIG. 7.

At 1325, the method may include measuring, in response to performing the random access procedure, a second reference signal received power for a second reference signal received from a second cell. The operations of 1325 may be performed in accordance with examples as disclosed herein. In some examples, aspects of the operations of 1325 may be performed by a neighbor cell measurement component 735 as described with reference to FIG. 7.

At 1330, the method may include calculating, based on performing the random access procedure, a transmission power for a random access preamble. The operations of 1330 may be performed in accordance with examples as disclosed herein. In some examples, aspects of the operations of 1330 may be performed by a transmission power calculation component 740 as described with reference to FIG. 7.

At 1335, the method may include triggering a radio link failure mode for the first cell based on the first reference signal received power being less than a first reference signal received power threshold, the second reference signal received power being greater than the first reference signal received power threshold, and the transmission power being greater than a transmission power threshold. The operations of 1335 may be performed in accordance with examples as disclosed herein. In some examples, aspects of the operations of 1335 may be performed by an RLF component 745 as described with reference to FIG. 7.

The following provides an overview of aspects of the present disclosure:

Aspect 1: A method for wireless communication at a UE, comprising: performing a random access procedure to establish a connection with a first cell; measuring, in response to performing the random access procedure, a first reference signal received power of a first reference signal received from a first cell; measuring, in response to performing the random access procedure, a second reference signal received power for a second reference signal received from a second cell; calculating, based at least in part on performing the random access procedure, a transmission power for a random access preamble; and triggering a radio link failure mode for the first cell based at least in part on the first reference signal received power being less than a first reference signal received power threshold, the second reference signal received power being greater than the first reference signal received power threshold, and the transmission power being greater than a transmission power threshold.

Aspect 2: The method of aspect 1, further comprising: using a reference signal received power threshold corresponding to a serving cell measurement reporting event as the first reference signal received power threshold based at least in part on the serving cell measurement reporting event being configured at the UE.

Aspect 3: The method of aspect 2, wherein using the reference signal received power threshold corresponding to serving cell measurement event comprises: using, as the first reference signal received power threshold, a minimum reference signal received power threshold of a plurality of reference signal received power thresholds corresponding to the serving cell measurement reporting event that is configured at the UE.

Aspect 4: The method of any of aspects 1 through 3, wherein triggering the radio link failure mode comprises: triggering the radio link failure mode based on a quantity of random access preamble transmissions exceeding a threshold quantity of random access preamble transmissions.

Aspect 5: The method of aspect 4, wherein the threshold quantity of random access preamble transmissions is half of a maximum quantity of preamble transmissions configured at the UE.

Aspect 6: The method of any of aspects 4 through 5, further comprising: determining that a serving cell measurement reporting event is not configured at the UE; and using a threshold corresponding to a minimum required receive power threshold in the first cell as the first reference signal received power threshold based at least in part on determining that the serving cell measurement reporting event is not configured at the UE.

Aspect 7: The method of any of aspects 1 through 6, wherein the transmission power threshold is a maximum output power of the UE.

Aspect 8: The method of any of aspects 1 through 7, further comprising: performing a handover procedure for the first cell, wherein the random access procedure is performed in response to performing the handover procedure.

Aspect 9: The method of aspect 8, wherein the handover procedure is a dual active protocol stack (DAPS) handover, a conditional handover (CHO), or a T312-based fast failure recovery handover.

Aspect 10: The method of any of aspects 1 through 9, further comprising: communicating via the second cell prior to performing the random access procedure; and receiving, from the second cell based at least in part on a measurement of the second cell, a handover command, wherein the random access procedure is performed in the first cell in response to receiving the handover command.

Aspect 11: The method of any of aspects 1 through 10, wherein the second cell is a neighbor cell and the UE communicates with a source cell prior to performing the random procedure in the first cell.

Aspect 12: The method of any of aspects 1 through 11, wherein triggering the radio link failure mode comprises: evaluating whether the first reference signal received power plus a hysteresis value is less than the first reference signal received power threshold, wherein the radio link failure mode for the first cell is triggered based at least in part on the first reference signal received power plus the hysteresis value being less than the first reference signal received power threshold.

Aspect 13: The method of any of aspects 1 through 12, wherein triggering the radio link failure mode comprises: evaluating whether the second reference signal received power plus a hysteresis value is greater than the first reference signal received power threshold, wherein the radio link failure mode for the first cell is triggered based at least in part on the second reference signal received power plus the hysteresis value being greater than the first reference signal received power threshold.

Aspect 14: The method of any of aspects 1 through 13, further comprising: performing, in response to triggering the radio link failure mode in the first cell, a cell reselection procedure; and establishing a connection with the second cell based at least in part on performing the cell reselection procedure.

Aspect 15: An apparatus for wireless communication at a UE, comprising a processor; memory coupled with the processor; and instructions stored in the memory and executable by the processor to cause the apparatus to perform a method of any of aspects 1 through 14.

Aspect 16: An apparatus for wireless communication at a UE, comprising at least one means for performing a method of any of aspects 1 through 14.

Aspect 17: A non-transitory computer-readable medium storing code for wireless communication at a UE, the code comprising instructions executable by a processor to perform a method of any of aspects 1 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
perform a random access procedure to establish a connection with a first cell;
measure, in response to performing the random access procedure, a first reference signal received power of a first reference signal received from a first cell;
measure, in response to performing the random access procedure, a second reference signal received power for a second reference signal received from a second cell;
calculate, based at least in part on performing the random access procedure, a transmission power for a random access preamble; and
trigger a radio link failure mode for the first cell based at least in part on the first reference signal received power being less than a first reference signal received power threshold, the second reference signal received power being greater than the first reference signal received power threshold, and the transmission power being greater than a transmission power threshold.

2. The apparatus of claim 1, wherein the instructions are further executable by the processor to cause the apparatus to:
use a reference signal received power threshold corresponding to a serving cell measurement reporting event as the first reference signal received power threshold based at least in part on the serving cell measurement reporting event being configured at the UE.

3. The apparatus of claim 2, wherein the instructions to use the reference signal received power threshold corresponding to serving cell measurement event are executable by the processor to cause the apparatus to:
use, as the first reference signal received power threshold, a minimum reference signal received power threshold of a plurality of reference signal received power thresholds corresponding to the serving cell measurement reporting event that is configured at the UE.

4. The apparatus of claim 1, wherein the instructions to trigger the radio link failure mode are executable by the processor to cause the apparatus to:
trigger the radio link failure mode based on a quantity of random access preamble transmissions exceeding a threshold quantity of random access preamble transmissions.

5. The apparatus of claim 4, wherein the threshold quantity of random access preamble transmissions is half of a maximum quantity of preamble transmissions configured at the UE.

6. The apparatus of claim 1, wherein the instructions are further executable by the processor to cause the apparatus to:
determine that a serving cell measurement reporting event is not configured at the UE; and
use a threshold corresponding to a minimum required receive power threshold in the first cell as the first reference signal received power threshold based at least in part on determining that the serving cell measurement reporting event is not configured at the UE.

7. The apparatus of claim 1, wherein the transmission power threshold is a maximum output power of the UE.

8. The apparatus of claim 1, wherein the instructions are further executable by the processor to cause the apparatus to:
perform a handover procedure for the first cell, wherein the random access procedure is performed in response to performing the handover procedure.

9. The apparatus of claim 8, wherein the handover procedure is a dual active protocol stack (DAPS) handover, a conditional handover (CHO), or a T312-based fast failure recovery handover.

10. The apparatus of claim 1, wherein the instructions are further executable by the processor to cause the apparatus to:
communicate via the second cell prior to performing the random access procedure; and
receive, from the second cell based at least in part on a measurement of the second cell, a handover command, wherein the random access procedure is performed in the first cell in response to receiving the handover command.

11. The apparatus of claim 1, wherein the second cell is a neighbor cell and the UE communicates with a source cell prior to performing the random procedure in the first cell.

12. The apparatus of claim 1, wherein the instructions to trigger the radio link failure mode are executable by the processor to cause the apparatus to:
evaluate whether the first reference signal received power plus a hysteresis value is less than the first reference signal received power threshold, wherein the radio link failure mode for the first cell is triggered based at least in part on the first reference signal received power plus the hysteresis value being less than the first reference signal received power threshold.

13. The apparatus of claim 1, wherein the instructions to trigger the radio link failure mode are executable by the processor to cause the apparatus to:
evaluate whether the second reference signal received power plus a hysteresis value is greater than the first reference signal received power threshold, wherein the radio link failure mode for the first cell is triggered based at least in part on the second reference signal received power plus the hysteresis value being greater than the first reference signal received power threshold.

14. The apparatus of claim 1, wherein the instructions are further executable by the processor to cause the apparatus to:
perform, in response to triggering the radio link failure mode in the first cell, a cell reselection procedure; and
establish a connection with the second cell based at least in part on performing the cell reselection procedure.

15. A method for wireless communication at a user equipment (UE), comprising:
performing a random access procedure to establish a connection with a first cell;
measuring, in response to performing the random access procedure, a first reference signal received power of a first reference signal received from a first cell;
measuring, in response to performing the random access procedure, a second reference signal received power for a second reference signal received from a second cell;
calculating, based at least in part on performing the random access procedure, a transmission power for a random access preamble; and
triggering a radio link failure mode for the first cell based at least in part on the first reference signal received power being less than a first reference signal received power threshold, the second reference signal received power being greater than the first reference signal received power threshold, and the transmission power being greater than a transmission power threshold.

16. The method of claim 15, further comprising:
using a reference signal received power threshold corresponding to a serving cell measurement reporting event as the first reference signal received power threshold based at least in part on the serving cell measurement reporting event being configured at the UE.

17. The method of claim 16, wherein using the reference signal received power threshold corresponding to serving cell measurement event comprises:
using, as the first reference signal received power threshold, a minimum reference signal received power threshold of a plurality of reference signal received power thresholds corresponding to the serving cell measurement reporting event that is configured at the UE.

18. The method of claim 15, wherein triggering the radio link failure mode comprises:
triggering the radio link failure mode based on a quantity of random access preamble transmissions exceeding a threshold quantity of random access preamble transmissions.

19. The method of claim 18, wherein the threshold quantity of random access preamble transmissions is half of a maximum quantity of preamble transmissions configured at the UE.

20. The method of claim 15, further comprising:
determining that a serving cell measurement reporting event is not configured at the UE; and
using a threshold corresponding to a minimum required receive power threshold in the first cell as the first reference signal received power threshold based at least in part on determining that the serving cell measurement reporting event is not configured at the UE.

21. The method of claim 15, wherein the transmission power threshold is a maximum output power of the UE.

22. The method of claim 15, further comprising:
performing a handover procedure for the first cell, wherein the random access procedure is performed in response to performing the handover procedure.

23. The method of claim 22, wherein the handover procedure is a dual active protocol stack (DAPS) handover, a conditional handover (CHO), or a T312-based fast failure recovery handover.

24. The method of claim 15, further comprising:
communicating via the second cell prior to performing the random access procedure; and
receiving, from the second cell based at least in part on a measurement of the second cell, a handover command, wherein the random access procedure is performed in the first cell in response to receiving the handover command.

25. The method of claim 15, wherein the second cell is a neighbor cell and the UE communicates with a source cell prior to performing the random procedure in the first cell.

26. The method of claim 15, wherein triggering the radio link failure mode comprises:
evaluating whether the first reference signal received power plus a hysteresis value is less than the first reference signal received power threshold, wherein the radio link failure mode for the first cell is triggered based at least in part on the first reference signal received power plus the hysteresis value being less than the first reference signal received power threshold.

27. The method of claim 15, wherein triggering the radio link failure mode comprises:
evaluating whether the second reference signal received power plus a hysteresis value is greater than the first reference signal received power threshold, wherein the radio link failure mode for the first cell is triggered based at least in part on the second reference signal received power plus the hysteresis value being greater than the first reference signal received power threshold.

28. The method of claim 15, further comprising:
performing, in response to triggering the radio link failure mode in the first cell, a cell reselection procedure; and
establishing a connection with the second cell based at least in part on performing the cell reselection procedure.

29. An apparatus for wireless communication at a user equipment (UE), comprising:
means for performing a random access procedure to establish a connection with a first cell;
means for measuring, in response to performing the random access procedure, a first reference signal received power of a first reference signal received from a first cell;
means for measuring, in response to performing the random access procedure, a second reference signal received power for a second reference signal received from a second cell;
means for calculating, based at least in part on performing the random access procedure, a transmission power for a random access preamble; and
means for triggering a radio link failure mode for the first cell based at least in part on the first reference signal received power being less than a first reference signal received power threshold, the second reference signal received power being greater than the first reference signal received power threshold, and the transmission power being greater than a transmission power threshold.

30. A non-transitory computer-readable medium storing code for wireless communication at a user equipment (UE), the code comprising instructions executable by a processor to:
perform a random access procedure to establish a connection with a first cell;
measure, in response to performing the random access procedure, a first reference signal received power of a first reference signal received from a first cell;
measure, in response to performing the random access procedure, a second reference signal received power for a second reference signal received from a second cell;
calculate, based at least in part on performing the random access procedure, a transmission power for a random access preamble; and
trigger a radio link failure mode for the first cell based at least in part on the first reference signal received power being less than a first reference signal received power threshold, the second reference signal received power being greater than the first reference signal received power threshold, and the transmission power being greater than a transmission power threshold.
